(19) United States
(12) Patent Application Publication
(10) Pub. No.: US 2006/0176702 A1
(43) Pub. Date: Aug. 10, 2006

(54) Warning lamp

(75) Inventors: Penn Q. Shen, Anaheim, CA (US); Long Bao Zhang, Anaheim, CA (US)

Correspondence Address: Raymond Y. Chan, 108 N. Ynez Ave., #128, Monterey Park, CA, 91754, US

(73) Assignee: A L Lightech, Inc.

(21) Appl. No.: 11/053,779

(22) Filed: Feb. 8, 2005

(51) Int. Cl. F21V 3/00; F21V 5/00

(52) U.S. Cl. 362/311

(57) ABSTRACT

A warning lamp includes a light housing having a light window, a converging element supported in the light housing at a position aligning with the light window, and a high intensity light source arrangement for generating high intensity light beams towards the converging element, wherein the converging element diverges the light beams to form collimated light beams so as to horizontally project out from the light window of the light housing in 360° direction.

### BACKGROUND OF THE PRESENT INVENTION

1. Field of Invention

The present invention relates to a lighting fixture, and more particularly to a warning lamp comprising a converging element to diverge high-intensity light beams from a light source in 360° direction.

2. Description of Related Arts

A conventional warning lamp are commonly used to indicate the existence of a hazardous situation, wherein the warning lamp comprises a light housing, a light source supported on a base of the light housing and a cone-shaped reflector supported above the light source and arranged in such a manner that when the light source upwardly projects light beams towards the reflector, the reflector reflects the upward light beams to collimated light beams as a warning signal so as to horizontally project out from the light housing in 360° direction. In order to enhance the warning signal, a motor or a driving rotor is mounted in the light housing to drive the reflector to rotate therewithin so as to provide an added flashing or strobe effect of the collimated light beams. However, such warning lamp has several drawbacks.

Since the upward light beams must be reflected by the reflector to form the collimated light beams, the intensity of the collimated light beam is relatively weak. For enhancing the intensity of the collimated light beam, the light source generally comprises a circuit board supported on the base of the light housing and a plurality of LEDs spacedly mounted on the circuit board such that each LED is adapted to emit a relatively strong light beam. However, the light is radially projected from each of the LEDs such that a portion of light is distracted from the respective LED before reaching the reflector so as to reduce the effective of the warning lamp.

In addition, the reflector comprises a mirror reflecting surface for reflecting the light beams from the light source. Such reflector is fragile that when an external impact force is exerted on the light housing, the reflector would be broken in pieces by the vibration of the light housing. It is worth to mention that once the reflector is broken, the upward light beams cannot be reflected by the reflector to form the collimated light beams such that the warning lamp misses its purposes to horizontally project out from the light housing in 360° direction.

### SUMMARY OF THE PRESENT INVENTION

A main object of the present invention is to provide a warning lamp comprising a converging element to diverge high-intensity light beams from a light source in 360° direction.

Another object of the present invention is to provide a warning lamp, wherein the converging element can substantially enhance the light intensity of the light beams emitted from the light source. In other words, the converging element converges the light beams emitted from the light source by total internal reflections such that no reflective coating is required.

Another object of the present invention is to provide a warning lamp, wherein the converging element embodies as a solid converging lens to guide the light beams to form collimated light beams by total internal reflections so as to substantially enhance the effective of the warning lamp and to prolong the service life span of the present invention.

Another object of the present invention is to provide a warning lamp, wherein the light source comprises a plurality of LEDs programmed to emit the light beams towards the diverging element such that no motor or driving rotor is needed to drive the converging element to rotate for producing flashing light effect. In other words, the warning lamp requires less mechanical component to not only minimize the malfunction of the warning lamp but also reduce the manufacturing cost of the warning lamp.

Another object of the present invention is to provide a warning lamp, which is simple in structure, easy to manufacture, convenient to use and does not involve complicated electronics, so as to minimize manufacturing and the ultimate selling price of the present invention.

Accordingly, in order to accomplish the above objects, the present invention provides a warning lamp, comprising:

a light housing having a light window;

a converging element supported in the light housing at a position aligning with the light window; and

a high intensity light source arrangement for generating high intensity light beams towards the converging element, wherein the converging element diverges the light beams to form collimated light beams so as to horizontally project out from the light window of the light housing in 360° direction.

These and other objectives, features, and advantages of the present invention will become apparent from the following detailed description, the accompanying drawings, and the appended claims.

### BRIEF DESCRIPTION OF THE DRAWINGS

FIG. 1A is a sectional view of a warning lamp according to a first preferred embodiment of the present invention.

FIG. 1B is an exploded perspective view of the warning lamp according to the above first preferred embodiment of the present invention.

FIG. 2 illustrates a first alternative mode of the warning lamp according to the above first preferred embodiment of the present invention.

FIG. 3 illustrates a second alternative mode of the warning lamp according to the above first preferred embodiment of the present invention.

FIGS. 4A and 4B illustrate a third alternative mode of the warning lamp according to the above first preferred embodiment of the present invention.

FIG. 5 is a sectional view of a warning lamp according to a second embodiment of the present invention.

FIG. 6 illustrates an alternative mode of the warning lamp according to the above second preferred embodiment of the present invention.

FIG. 7 illustrates an application of the warning lamp according to the above first and second preferred embodiments of the present invention.

### DETAILED DESCRIPTION OF THE PREFERRED EMBODIMENT

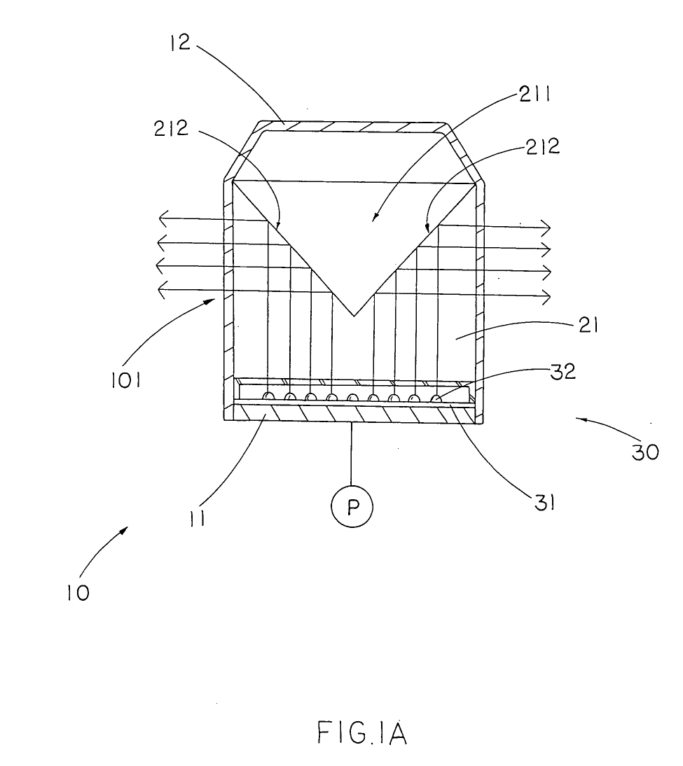

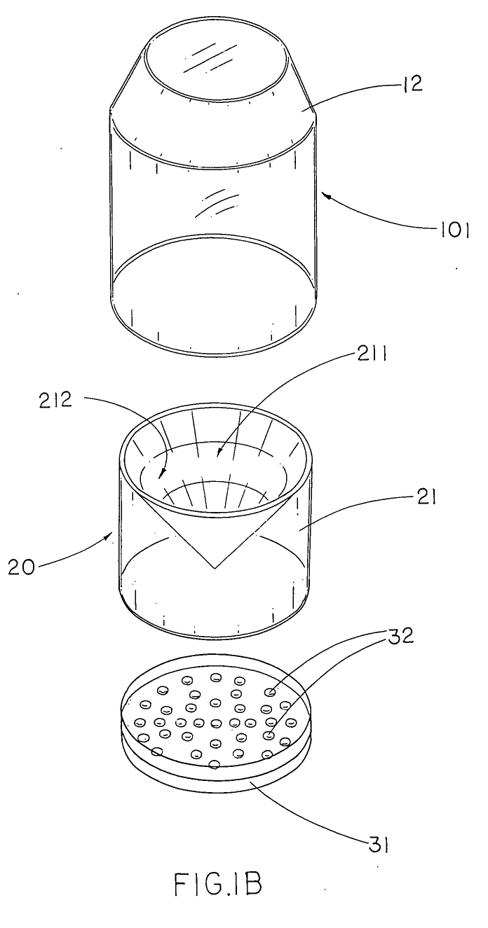

Referring to FIGS. 1A and 1B of the drawings, a warning lamp according to a first preferred embodiment of the present invention is illustrated, wherein the warning lamp comprises a light housing 10 having a light window 101, a converging element 20 supported in the light housing 10 at a position aligning with the light window 101, a high intensity light source arrangement 30, which is electrically connected to a power source P, for generating high intensity light beams towards the converging element 20, wherein the converging element 20 diverges the light beams to form collimated light beams so as to horizontally project out from the light window 101 of the light housing 10 in 360° direction.

According to the preferred embodiment, the light housing 10 comprises a supporting base 11 and a transparent shelter 12 forming the light window 101. The light housing 10 is made of light but durable material to protect the converging element 20 and the high intensity light source arrangement 30.

As shown in FIGS. 1A and 1B, the converging element 20 comprises a lens body 21, which is disposed within the light housing 10, has an air chamber 211 to form a slanted diffraction surface 212 at a peripheral wall of the air chamber 211, wherein a diffraction density of the lens body 21 is higher than a diffraction density of air. Accordingly, the lens body 21 is solid member disposed in the transparent shelter 12 that the air chamber 211, having a cone shape, is formed in the solid member to align with the light window 101 of the light housing 10. The diffraction surface 212 is inclinedly extended at a diffraction angle.

Accordingly, the lens body 21 and the air chamber 211 have different diffraction densities respectively in such a manner that the light passing from the lens body 21 is arranged to be diffracted at the diffraction surface 212 in accordance with the well-established Snell's Law of diffraction. In particular, the incidence angle of the light beams impinging on the diffraction surface 212 is greater than a threshold angle of total internal reflection in accordance with a ratio of diffraction density of the lens body 21 and the air chamber 211, such that light impinging on the diffraction surface 212 will be reflected by total internal reflection. As a result, the reflected light beams form the collimated light beams and emit out of the light window 101 of the light housing 10 in 360° direction, as shown in FIG. 1A.

According to the preferred embodiment, the lens body 21 is made of Polycarbonate integrally formed within the light housing 10 wherein the threshold angle for total internal reflection is around 39°, meaning that an incidence angle greater than 39° would be reflected by the diffraction surface 212. A practical alternative for the lens body 21 would be Acrylonitrile-Butadiene-Styrene (ABS), which has a threshold angle of around 42°.

The air chamber 211, having a cone shape, is encircled within the light window 101 of the light housing 10 wherein the diffraction surface 212 is upwardly and outwardly extended to form the slant peripheral wall of the air chamber 211 that a vertex of the air chamber 211 is downwardly pointing to the high intensity light source arrangement 30.

The high intensity light source arrangement 30 comprises a circuit board 31 supported on the supporting base 11 of the light housing 10 and a plurality of LEDs 32 electrically mounted on the circuit board 31 to upwardly project the light beams penetrating through the lens body 21, wherein when the light beams reach the diffraction surface 212 at an angle larger than the diffraction angle, the light beams are substantially reflected at the diffraction surface 212 to form the collimated light beams so as to horizontally project out from the light window 101 of the light housing 10 in 360° direction.

As shown in FIG. 1A, the lens body 21 is positioned right above the LEDs 32 such that when each of the LEDs 32 radially project the light towards the converging element 20, the light is converged to form the light beam upwardly penetrating through the lens body 21. In other words, the lens body 21 enhances the efficiency of the high intensity light source arrangement 30.

According to the preferred embodiment, the operation of each of the LEDs 32 is programmably controlled by the circuit board 31. Therefore, the circuit board 31 is adapted to switch on all the LEDs 32 that the light beams therefrom are horizontally projected from the light window 101 of the light housing 10 in 360° direction. Alternatively, the circuit board 31 selectively switches on the LEDs 32 in a sequent order such that the collimated light beams are horizontally projected out from the light window 101 of the light housing 10 in 360° rotational direction. In other words, no motor or driving rotor is needed to drive the converging element 20 to rotate for producing flashing light effect such that the warning lamp of the present invention requires less mechanical component to not only minimize the malfunction of the warning lamp but also reduce the manufacturing cost of the warning lamp.

It is worth to mention that the high intensity light source arrangement 30 is not limited to LED, since the theory of total internal reflection applies to virtually any source of visible light, a wide variety forms of light source may be utilized as the high intensity light source arrangement 30.

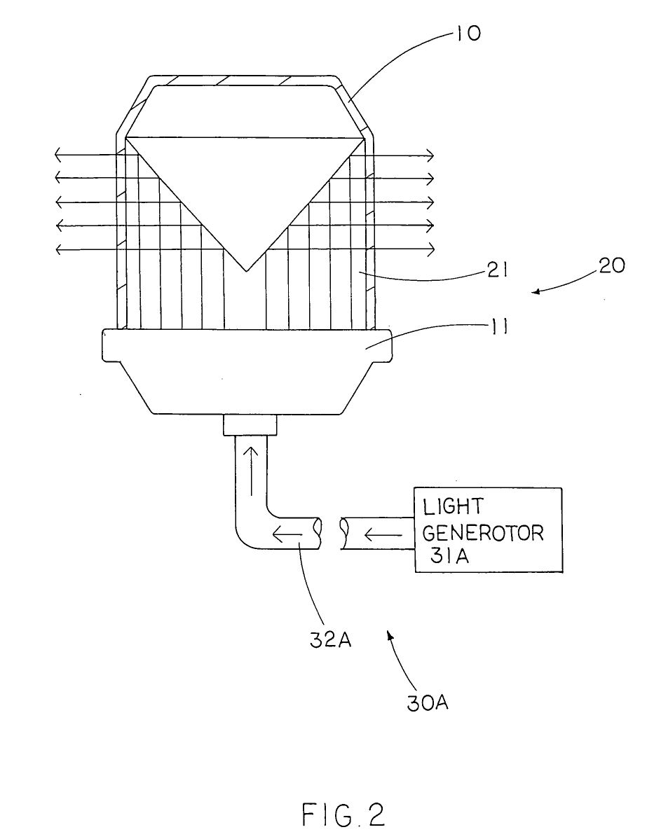

As shown in FIG. 2, the high intensity light source arrangement 30A comprises a light generator 31A spaced apart from the light housing 10 and a light transmitting cable 32A extended from the light generator 31A to the supporting base 11 of the light housing 10 for directing the light beams from the light generator 31A to the lens body 21 of the converging element 20. Accordingly, the light generator 31A is adapted to generate a high intensity light beam and/or colored light beam with flashing effect. The light transmitting cable 32A is embodied as an optical fiber to transmit the light beam to the light housing 10. Therefore, the light generator 31A can be located away from the light housing 10 to enhance the practice use of the warning lamp. For example, only the light housing 10 and the converging element 20 are mounted on the ambulance while the high intensity light source arrangement 30A is installed into the ambulance such that no electric component and/or electrical connection is required to an exterior of the ambulance.

To enhance the illuminated warning effect, an additional high intensity light source arrangement 30B is mounted on top of the light housing 10, wherein the additional high intensity light source arrangement 30B comprises a circuit board 31B supported on top of the light housing 10 and a plurality of LEDs 32B electrically mounted on the circuit board 31B to downwardly project the light beams towards the converging element 20B.

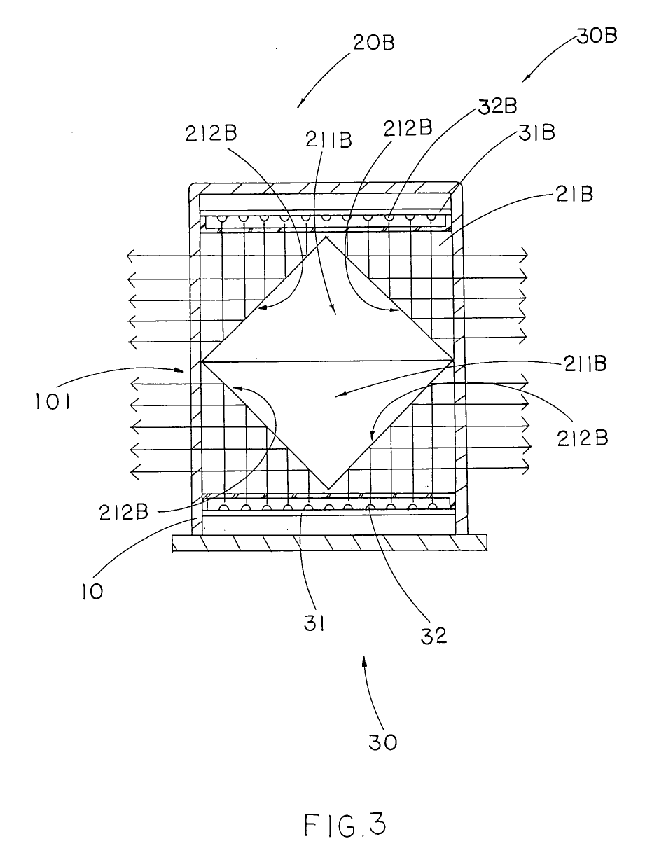

As shown in FIG. 3, the converging element 20B comprises a lens body 21B, which is disposed within the light housing 10, has an air chamber 211B to form upper and lower diffraction surfaces 212B at a slant peripheral wall of the air chamber 211B, wherein a diffraction density of the lens body 21B is higher than a diffraction density of air. Accordingly, the lens body 21B is a solid member disposed in the transparent shelter 12. The air chamber 211B, having an overlapped double cone shape, is formed in the solid member to align with the light window 101 of the light housing 10 to form the upper and lower diffraction surfaces 212B. Each of the diffraction surfaces 212B is inclinedly extended at a diffraction angle that the top vertex of the air chamber 211B is upwardly pointing to the upper high intensity light source arrangement 30B and the bottom vertex of the air chamber 211B is downwardly pointing to the bottom high intensity light source arrangement 30.

Accordingly, the lens body 21B is positioned between the two high intensity light source arrangement 30, 30B, wherein when the light beams from the LEDs 32, 32B reach the diffraction surface 212B at an angle larger than the diffraction angle, the light beams are substantially reflected at the diffraction surface 212B to form the collimated light beams so as to horizontally project out from the light window 101 of the light housing 10 in 360° direction. Since there are two sets of high intensity light source arrangement 30, 30B, the warning lamp is adapted to generate two different light patterns, such color or flashing rate, at the upper and lower portions of the light housing 10 through the light window 101.

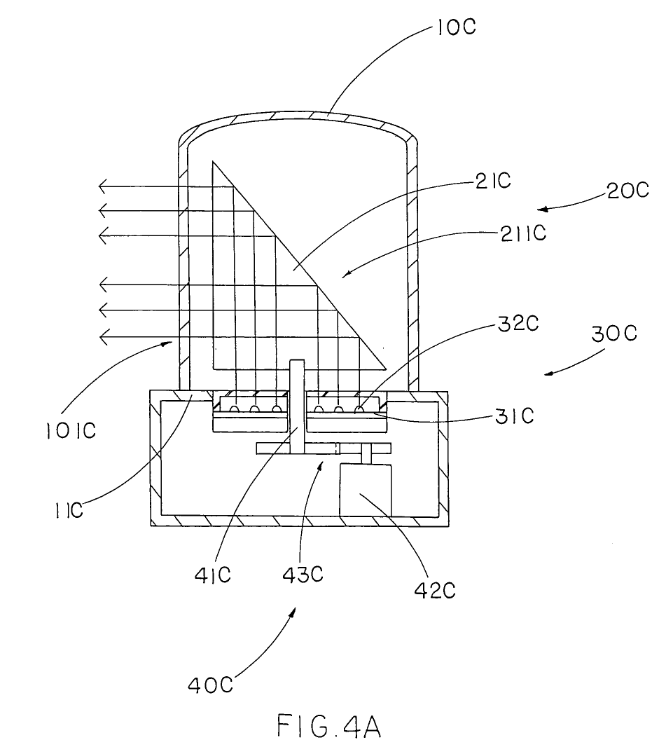

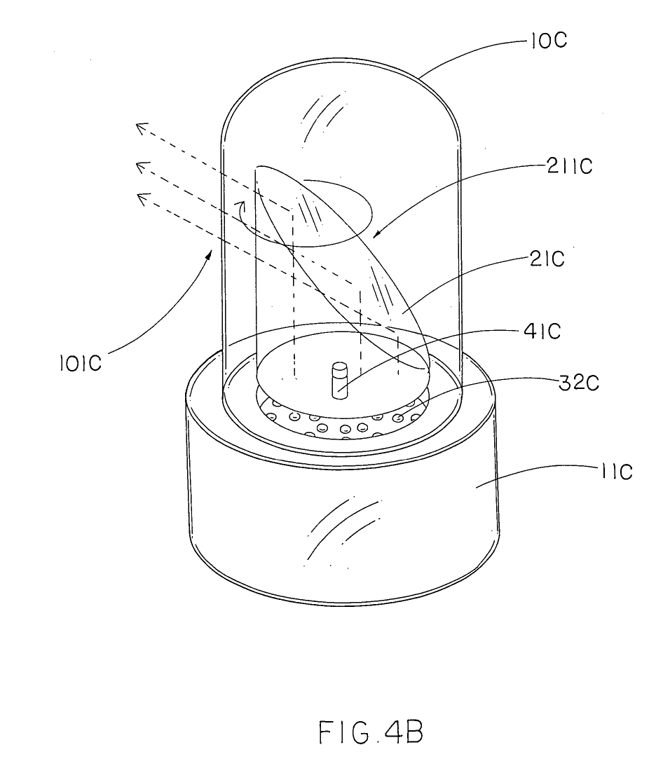

FIGS. 4A and 4B illustrate another alternative mode of the warning lamp according to the first embodiment of the present invention. The converging element 20C comprises a solid lens body 21C supported within the light housing 10C at a position right above the high intensity light source arrangement 30C, wherein the lens body 20C has a slanted top reflecting surface 211C extended a diffraction angle, wherein a diffraction density of the a lens body 21C is higher than a diffraction density than air.

The high intensity light source arrangement 30C comprises a circuit board 31C supported on the supporting base 11C of the light housing 10C and a plurality of LEDs 32C electrically mounted on the circuit board 31C to upwardly project the light beams penetrating through the lens body 21C, wherein when the light beams reach the top reflecting surface 211C at an angle larger than the diffraction angle, the light beams are substantially reflected at the top reflecting surface 211C to form the collimated light beams so as to horizontally project out from the light window 101C of the light housing 10C in 360° direction. In other words, when each of the LEDs 32C radially project the light towards the converging element 20C, the light is converged to form the light beam upwardly penetrating through the lens body 21C to reach the top reflecting surface 211C thereof, as shown in FIGS. 4A and 4B. Accordingly, the lens body 21C is made of Polycarbonate or Acrylonitrile-Butadiene-Styrene (ABS). In addition, the light generator 31A and the light transmitting cable 32A of the high intensity light source arrangement 30A can be alternatively incorporated with the lens body 21C.

As shown in FIG. 4, the warning lamp further comprises a driving unit 40C for driving the lens body 21C to rotate in the light housing 10C, wherein the driving unit 40C comprises a driving shaft 41C downwardly extended from the lens body 21C through the circuit board 31C and a motor device 42C supported in the supporting base 11 at a position underneath the circuit board 32C to drive the driving shaft 41C to rotate through a gear unit 43C. Therefore, the collimated light beams reflected by the top reflecting surface 211C of the lens body 21C are horizontally projected out from the light window 101C of the light housing 10C in 360° rotational direction.

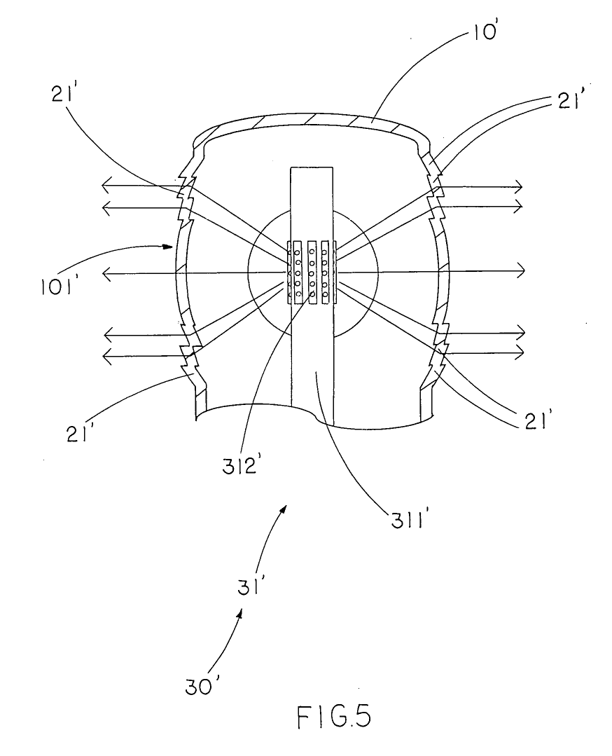

As shown in FIG. 5, a warning lamp of a second embodiment illustrates an alternative mode of the first embodiment of the present invention. The converging element 20′ comprises a plurality of lens rings 21′ integrally formed on a peripheral wall of the light housing 10′ at the light window 101′ thereof wherein each of the lens rings 21′ is inclinedly extended at a diffraction angle for diverging the light beams to form collimated light beams.

The high intensity light source arrangement 30′ comprises a 360° LED emitter 31′ coaxially supported within the light housing 10′ for generating the light beams in 360° radial direction, wherein the light beams are diffracted by the lens rings 21′ to form the collimate light beams so as to horizontally project out from the light window 101′ of the light housing 10′ in 360° direction.

Accordingly, the 360° LED emitter 31′ comprises a supporter 311′ having a circuit printed thereon and a plurality of diodes 312′ supported on the supporter 311′ to electrically connect to the circuit for generating the light beams in 360° radial direction. As shown in FIG. 5, the diodes 312′ are coaxially positioned the lens rings 21′ wherein when the radial light beams are projected towards the lens rings 21′, each of the lens rings 21′ is inclined at the predetermined diffraction angle to self-adjust the radial light beam to become the collimated light beam. The supporter 311′ is embodied as a heat sink to dissipate the heat generated from the diodes 312′ as well.

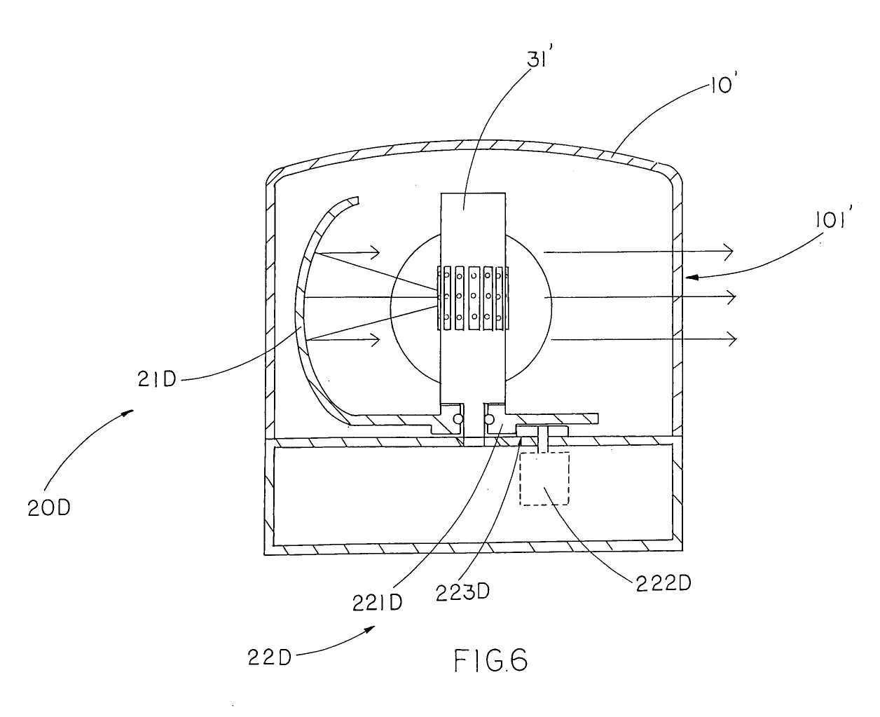

FIG. 6 illustrates an alternative mode of the converging element 20D which is rotatably supported in the light housing 10′. The converging element 20D comprises a reflective mirror 21D supported in the light housing 10′ for reflecting the light beams from the 360° LED emitter 31′ and a driving unit 22D driving the reflective mirror 21D to 360° rotate with respect to the 360° LED emitter 31′. Accordingly, the reflective mirror 21D is radially positioned to the 360° LED emitter 31′ to substantially reflect a portion of light from the 360° LED emitter 31′. Preferably, the reflective mirror 21D is a concave mirror wherein the 360° LED emitter 31′ is positioned at a focal point of the reflective mirror 21D such that the reflective mirror 21D reflects the radial light beams from the 360° LED emitter 31′ to form the collimated light beams so as to horizontally project out from the light window 101′ of the light housing 10′ in 360° rotational direction.

The driving unit 22D comprises a driving shaft 221D downwardly extended from the reflective mirror 21D and a motor device 222D supported in the supporting base 11′ to drive the driving shaft 221D to rotate through a gear unit 223D. Therefore, the collimated light beams reflected by the reflective mirror 21D are horizontally projected out from the light window 101′ of the light housing 10′ in 360° rotational direction.

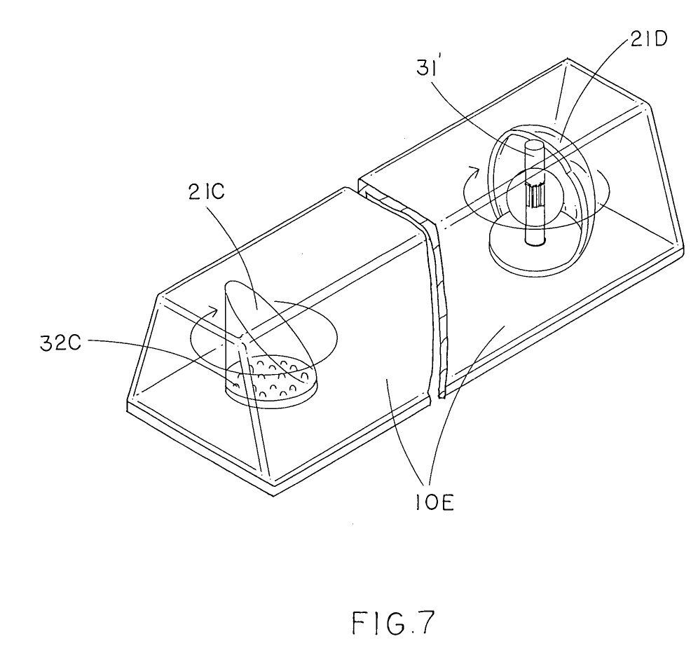

As shown in FIG. 7, the warning lamp of the first and second embodiments can be used for the siren light of a vehicle such as highway patrol or ambulance wherein the warning lamp can be formed as a single light cell to generate the collimate light beams in 360° rotational direction such that a plurality of warning lamps are alignedly received in an elongated housing 10E to form an emergency light system of the vehicle.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A warning lamp, comprising:
a light housing having a light window;
a converging element supported in said light housing at a position aligning with said light window;
a high intensity light source arrangement for generating high intensity light beams towards said converging element, wherein said converging element diverges said light beams to form collimated light beams so as to horizontally project out from said light window of said light housing.

2. The warning lamp, as recited in claim 1, wherein said converging element comprises a lens body, which is disposed in said light housing at a position, having an air chamber and a slanted diffraction surface at a peripheral wall of said air chamber, wherein a diffraction density of said lens body is higher than a diffraction density of air, wherein when said light beams penetrates through said lens body to reach said diffraction surface, said light beams are substantially reflected at said diffraction surface to form said collimated light beams so as to horizontally project out from said light window of said light housing.

3. The warning lamp, as recited in claim 2, wherein said air chamber, having a cone shape, is encircled within said light window of said light housing, wherein said diffraction surface is upwardly and outwardly extended to form said peripheral wall of said air chamber that a vertex of said air chamber is downwardly pointing to said high intensity light source arrangement.

4. The warning lamp, as recited in claim 2, wherein said high intensity light source arrangement comprises a circuit board supported in said light housing and a plurality of LEDs electrically mounted on said circuit board to project said light beams penetrating through said lens body, wherein when said light beams reach said diffraction surface at an angle larger than a diffraction angle, said light beams are substantially reflected at said diffraction surface to form the collimated light beams so as to horizontally project out from said light window of said light housing.

5. The warning lamp, as recited in claim 3, wherein said high intensity light source arrangement comprises a circuit board supported in said light housing and a plurality of LEDs electrically mounted on said circuit board to project said light beams penetrating through said lens body, wherein when said light beams reach said diffraction surface at an angle larger than a diffraction angle, said light beams are substantially reflected at said diffraction surface to form the collimated light beams so as to horizontally project out from said light window of said light housing.

6. The warning lamp, as recited in claim 4, wherein said circuit board is programmed to selectively switch on said LEDs in a sequent order such that said collimated light beams are horizontally projected out from said light window of said light housing in 360° rotational direction.

7. The warning lamp, as recited in claim 5, wherein said circuit board is programmed to selectively switch on said LEDs in a sequent order such that said collimated light beams are horizontally projected out from said light window of said light housing in 360° rotational direction.

8. The warning lamp, as recited in claim 3, wherein said lens body is made of Polycarbonate.

9. The warning lamp, as recited in claim 7, wherein said lens body is made of Polycarbonate.

10. The warning lamp, as recited in claim 3, wherein said lens body is made of Acrylonitrile-Butadiene-Styrene (ABS).

11. The warning lamp, as recited in claim 7, wherein said lens body is made of Acrylonitrile-Butadiene-Styrene (ABS).

12. The warning lamp, as recited in claim 2, wherein said high intensity light source arrangement comprises a light generator spaced apart from said light housing and a light transmitting cable extended from said light generator to said light housing for directing said light beams from said light generator to said lens body of said converging element.

13. The warning lamp, as recited in claim 3, wherein said high intensity light source arrangement comprises a light generator spaced apart from said light housing and a light transmitting cable extended from said light generator to said light housing for directing said light beams from said light generator to said lens body of said converging element.

14. The warning lamp, as recited in claim 1, wherein said converging element comprises a solid lens body, which is supported within said light housing at a position right above said high intensity light source arrangement, having a slanted top reflecting surface extended a diffraction angle, wherein a diffraction density of said a lens body is higher than a diffraction density than air.

15. The warning lamp, as recited in claim 14, wherein said high intensity light source arrangement comprises a circuit board supported in said light housing and a plurality of LEDs electrically mounted on said circuit board to project said light beams penetrating through said lens body, wherein when said light beams reach said top reflecting surface at an angle larger than said diffraction angle, said light beams are substantially reflected at said top reflecting surface to form the collimated light beams so as to horizontally project out from said light window of said light housing.

16. The warning lamp, as recited in claim 15, further comprising a driving unit for driving said lens body to rotate in said light housing, wherein said driving unit comprises a driving shaft downwardly extended from said lens body through said circuit board and a motor device supported in said supporting base at a position underneath said circuit board to drive said driving shaft to rotate.

17. The warning lamp, as recited in claim 16, wherein said lens body is made of Polycarbonate.

18. The warning lamp, as recited in claim 16, wherein said lens body is made of Acrylonitrile-Butadiene-Styrene (ABS).

19. The warning lamp, as recited in claim 1, wherein said high intensity light source arrangement comprises a 360° LED emitter coaxially supported within said light housing for generating said light beams in 360° radial direction, wherein said light beams are diverged to form said collimate light beams so as to horizontally project out from said light window of said light housing in 360° direction.

20. The warning lamp, as recited in claim 19, wherein said converging element comprises a plurality of lens rings integrally formed on a peripheral wall of said light housing at said light window thereof, wherein each of said lens rings is inclinedly extended at a diffraction angle for diverging said light beams to form collimated light beams.

21. The warning lamp, as recited in claim 19, wherein said converging element comprises a reflective mirror supported in said light housing for reflecting said light beams from said 360° LED emitter and a driving unit driving said reflective mirror to 360° rotate with respect to said 360° LED emitter.

22. The warning lamp, as recited in claim 21, wherein said reflective mirror is a concave mirror, wherein said 360° LED emitter is positioned at a focal point of said reflective mirror such that said reflective mirror reflects said radial light beams from said 360° LED emitter to form said collimated light beams so as to horizontally project out from said light window of said light housing in 360° rotational direction.
